(19) United States
(12) Patent Application Publication
(10) Pub. No.: US 2020/0388854 A1
(43) Pub. Date: Dec. 10, 2020

(54) CERMET ELECTRODE FOR SOLID STATE AND LITHIUM ION BATTERIES

(71) Applicant: THE REGENTS OF THE UNIVERSITY OF MICHIGAN, Ann Arbor, MI (US)

(72) Inventors: JEFFREY S. SAKAMOTO, ANN ARBOR, MI (US); NATHAN JOHN TAYLOR, ANN ARBOR, MI (US)

(21) Appl. No.: 16/883,579

(22) Filed: May 26, 2020

Related U.S. Application Data
(60) Provisional application No. 62/853,312, filed on May 28, 2019.

(51) Int. Cl. H01M 4/66; H01M 4/62; H01M 4/131; H01M 4/525; H01M 4/58; H01M 4/36; H01M 4/134; H01M 4/04; H01M 10/0525

(52) U.S. Cl. CPC H01M 4/664; H01M 4/623; H01M 4/131; H01M 4/525; H01M 4/58; H01M 4/364; H01M 2004/021; H01M 4/134; H01M 4/0471; H01M 10/0525; H01M 2300/0068; H01M 2300/0042; H01M 4/662

(57) ABSTRACT

The present disclosure relates to electrochemical devices, such as lithium battery electrodes, and solid-state lithium ion and lithium metal batteries including these electrodes. This invention also relates to methods for making such electrochemical devices. The present disclosure provides a porous ceramic-metal (cermet) cathode for supporting the solid electrolyte in a battery whereby the conductive additive adheres cathode particles and is the conductive diluent. The cermet cathode is processed to not only achieve adequate mechanical integrity to support thin solid-electrolyte layers but also to include interconnected porosity to allow permeating of a liquid, gel, or polymer electrolyte.

### CROSS-REFERENCES TO RELATED APPLICATIONS

This application claims priority to U.S. Patent Application No. 62/853,312 filed May 28, 2019.

### STATEMENT REGARDING FEDERALLY SPONSORED RESEARCH

This invention was made with government support under DE-AR-0000653 awarded by the Department of Energy. The government has certain rights in the invention.

### BACKGROUND OF THE INVENTION

### 1. Field of the Invention

This invention relates to electrochemical devices, such as lithium ion battery electrodes, solid-state lithium ion and lithium metal batteries including these electrodes. This invention also relates to methods for making such electrochemical devices.

### 2. Description of the Related Art

The U.S. Department of Energy's Office of Energy Efficiency & Renewable Energy Electric Vehicle Everywhere Grand Challenge requires a breakthrough in energy storage technology. State-of-the-art (SOA) lithium-ion technology is currently used in low volume production plug-in hybrid and niche high performance vehicles; however, widespread adoption of electrified powertrains requires 25% lower cost, 4× higher performance, and safer batteries without the possibility of fire. One approach is to develop a solid-state battery (SSB) technology. SSBs offer the promise of 3×-4× the energy density compared to the SOA at a reduction in the pack cost of 20%. SSBs require fully solid-state composite cathodes with significant transport to allow facile movement of ions and electrons to a discrete cathode phase.

Conventional lithium-ion batteries are constructed with an anode, cathode, and porous polymer separator. Current SOA anode electrodes include graphite active material bound with a binder such as styrene butadiene copolymer. The mixture is typically cast onto a current collector, such as copper foil. Current SOA cathode electrodes include an active material, a conductive additive such as carbon black, and a polymeric binder, typically poly(vinylidene fluoride) (PVDF). The mixture is typically applied to a foil current collector, typically aluminum, by doctor blade, slot die, or similar coating methods. After drying and calendering, the electrode is ready for cell assembly. The anode, cathode, and polymer separator are assembled to form cylindrical or prismatic geometries, which are filled with liquid electrolyte and sealed. The lithium-ion cells formed using this process and SOA materials can achieve ˜600 Wh/L, but are not expected to improve in performance.

Solid state batteries offer a breakthrough increase in energy density, up to 1200 Wh/L and are non-flammable, versus a standard lithium ion battery, mainly through the replacement of the graphite anode of lithium-ion with lithium metal. One approach to enable the use of lithium metal negative electrode is the integration of a solid-state electrolyte (SSE). The SSE conducts only lithium-ions, is stable against lithium metal, and is compatible with cathodes. There are multiple approaches to integrate the positive electrode for bulk solid-state batteries. One form is the fully solid-state composite cathode including a solid electrolyte, active material, and conductive additive. This approach is difficult to reduce to practice due to chemical interactions between the constituents during processing. Additionally, volumetric strain of typical active materials upon delithiation may be constrained in dense solid-state composite cathodes, limiting cycling performance.

In another approach, the advantages of solid electrolyte stability towards metallic lithium could be combined with a polymer based solid electrolyte in a composite cathode system. In the most basic approach, a solid electrolyte and lithium metal negative electrode could be combined with a standard lithium-ion cathode where liquid electrolyte is used within the cathode only. These approaches offer the lowest risk path to next generation lithium batteries.

Any new battery design utilizing lithium metal must contend with the volumetric change within the cell as lithium is plated and stripped during cycling. Outside of the all-solid-state approach, this means the solid electrolyte is supported only by a thin layer of soft, ductile lithium that significantly changes in size during cycling. Most solid electrolytes, such as Li₇La₃Zr₂O₁₂ (LLZO), are brittle, and unsupported solid electrolytes could easily fail mechanically. In conventional lithium-ion batteries, positive electrodes are not load bearing as the particle constituents are adhered together with low volume fractions of a polymer binder (such as PVDF) and are porous. Since typical solid electrolytes are brittle, and must contend with stresses from volume change of the lithium anode, a mechanically robust cathode electrode is needed.

The manufacturing processes of batteries require the uses of polymer binders such as PVDF. Dissolving PVDF and other binders into slurries for lithium-ion roll-to-roll manufacturing requires hazardous solvents such as N-Methyl-2-pyrrolidone (NMP). The hazardous solvents must be removed and collected by heating the slurries. Thus, there is a significant incentive to eliminate these hazardous solvents in battery manufacturing. One way to make a binder free cathode is to sinter an active material, such as lithium cobalt oxide, into a porous body which is then infiltrated by a liquid electrolyte. [See, e.g., W. Lai et al., Adv. Mater. 2010, 22, 20, E139-E144.] However, these porous cathode bodies have low mechanical strength and fracture toughness.

What is needed therefore is a porous and binder free cathode body having high mechanical strength and fracture toughness that can support a solid electrolyte in a battery.

### SUMMARY OF THE INVENTION

The present disclosure provides a porous ceramic-metal (cermet) cathode for supporting the solid electrolyte in a battery whereby the conductive additive adheres cathode particles and is the conductive diluent. Cermet is a composite material with discrete ceramic and metallic phases. The cermet cathode is processed to not only achieve adequate mechanical integrity to support thin solid-electrolyte layers but also include interconnected porosity to allow permeating of a liquid, gel, or polymer electrolyte. Other conventional conductive additives may be completely or partially substituted by the metallic material.

In one aspect, the present disclosure provides a cathode comprising: a lithium host material; and a metallic material, wherein the lithium host material is bound together with the metallic material serving as a binder and an electronic conductor. The cathode can be a cermet cathode. The lithium host material can be selected from the group consisting of lithium metal oxides wherein the metal is one or more aluminum, cobalt, iron, manganese, nickel and vanadium, and lithium-containing phosphates having a general formula LiMPO₄ wherein M is one or more of cobalt, iron, manganese, and nickel. The lithium host material can be selected from the group consisting of LiFePO₄, LiCoPO₄, Li(CoₓFe_{y}Ni_{z})PO₄, LiCoO₂, Li(NiₓMn_{y}Co_{z})O₂, Li(NiₓCo_{y}Al_{z})O₂, LiNiO₂, Li(NiₓMn_{y})O₄, or LiMn₂O₄, wherein x+y+z=1.

A liquid electrolyte can be contained within pores of the cathode. The liquid electrolyte can comprise a solvent and a lithium salt. The lithium salt can be selected from the group consisting of LiN(CF₃SO₂)₂ (LiTFSI), lithium bis(fluorosulfonyl)imide (LiFSI), LiCF₃SO₃ (LiTf), lithium bis(oxalato)borate (LiBOB), LiPF₆, Lil, LiBF₄, LiBr, LiCl, LiF, Li₂SO₄, lithium bis(trifluoromethanesulfonyl)azanide (LiTFSA), LiCF₃SO₃, and mixtures thereof. The solvent can be selected from the group consisting of propylene carbonate (PC), dimethyl sulfoxide (DMSO), dimethylformamide (DMF), dimethylacetamide (DMAc), fluorinated ethers, fluorinated linear carboxylates, γ-butyrolactone, fluorinated γ-butyrolactone, tetraethylene glycol dimethyl ether, triethylene glycol dimethyl ether, bis(2-methoxyethyl) ether, ethyl methyl sulfone, allyl methyl sulfone, high oxidative stability solvents, and mixtures thereof. The liquid electrolyte can be entrapped in a solid gel network comprising poly(vinylidene fluoride-co-hexafluoropropylene) (PVDF-HFP), poly(methyl methacrylate) (PMMA), polyacrylonitrile (PAN), poly-(D)-glucosamine, polyethylene oxide (PEO), polyvinyl chloride (PVC), a polysaccharide, polyethylene glycol dimethacrylate (PEG-DMA), or polyvinylpyrrolidone (PVP). A polymer electrolyte can be contained within pores of the cathode. The polymer electrolyte can comprise a polymer matrix and a lithium salt. The polymer matrix can comprise a polymer selected from the group consisting of polyethylene oxide (PEO), polypropylene oxide (PPO), poly[bis(methoxy-ethoxy-ethoxy)phosphazene] (MEEP), polysiloxane (PSi), and mixtures thereof, and the lithium salt can be selected from the group consisting of LiClO₄, LiBF₄, LiPF₆, LiAsF₆, LiCF₃SO₃, LiN(CF₃SO₂)₂, and mixtures thereof.

In one version of the cathode, the metallic material comprises an elementally pure metal or an alloy thereof. The metallic material can comprises 0.1 to 20 volume percent based on a total volume of the metallic material and the lithium host material. The metallic material can comprise 1 to 10 volume percent based on a total volume of the metallic material and the lithium host material. The metallic material can comprise elementally pure aluminum or an alloy thereof. The metallic material can be in a form selected from powder, flake, platelet, wire, nanowire, or vacuum metallized pigment.

In one version of the cathode, the cathode is porous. The cathode can have a porosity of 20% to 55%, or the cathode can have a porosity of 20% to 35%. The cathode can have a peak flexural strength of greater than 50 MPa as measured by a three-point bend test according to test standard ASTM D7264. The cathode can have a peak flexural strength of greater than 100 MPa as measured by a three-point bend test according to test standard ASTM D7264. The cathode can have a peak flexural strength of greater than 150 MPa as measured by a three-point bend test according to test standard ASTM D7264. In one version of the cathode, the cathode is free of binder other than the metallic material. In one version of the cathode, the cathode is free of conductive carbon.

In another aspect, the present disclosure provides an electrochemical device comprising a cathode of the present disclosure; an anode; and a solid state electrolyte between the anode and the cathode. The solid state electrolyte can comprise an electrolyte material having the formula LiᵤReᵥM_{w}AₓO_{y}, wherein
Re can be any combination of elements with a nominal valance of +3 including La, Nd, Pr, Pm, Sm, Sc, Eu, Gd, Tb, Dy, Y, Ho, Er, Tm, Yb, and Lu;
M can be any combination of metals with a nominal valance of +3, +4, +5 or +6 including Zr, Ta, Nb, Sb, W, Hf, Sn, Ti, V, Bi, Ge, and Si;
A can be any combination of dopant atoms with nominal valance of +1, +2, +3 or+4 including H, Na, K, Rb, Cs, Ba, Sr, Ca, Mg, Fe, Co, Ni, Cu, Zn, Ga, Al, B, and Mn;
u can vary from 3-7.5;
v can vary from 0-3;
w can vary from 0-2;
x can vary from 0-2; and
y can vary from 11-12.5.

In the electrochemical device, the anode can comprise an anode material selected from the group consisting of graphite, lithium metal, lithium titanium oxides, hard carbon, tin/cobalt alloy, or silicon/carbon. The anode can comprise lithium metal.

In another aspect, the present disclosure provides a method for forming an electrode for an electrochemical device. The method comprises (a) depositing a metallic material on a powdered lithium host material; (b) forming a slurry comprising the metallic material coated lithium host material; (c) placing the slurry on a surface to form a layer; and (d) sintering the layer to form the electrode. The electrode can be a cathode. The lithium host material can be selected from the group consisting of lithium metal oxides wherein the metal is one or more aluminum, cobalt, iron, manganese, nickel and vanadium, and lithium-containing phosphates having a general formula LiMPO₄ wherein M is one or more of cobalt, iron, manganese, and nickel. The lithium host material can be selected from the group consisting of LiFePO₄, LiCoPO₄, Li(CoₓFe_{y}Ni_{z})PO₄, LiCoO₂, Li(NiₓMn_{y}Co_{z})O₂, Li(NiₓCo_{y}Al_{z})O₂, LiNiO₂, Li(NiₓMn_{y})O₄, or LiMn₂O₄, wherein x+y+z=1.

In the method, the metallic material can comprise an elementally pure metal or an alloy thereof. The metallic material can comprise 0.1 to 20 volume percent based on a total volume of the metallic material and the lithium host material. The metallic material can comprise 1 to 10 volume percent based on a total volume of the metallic material and the lithium host material. The metallic material can comprise elementally pure aluminum or an alloy thereof. The metallic material can be in a form selected from powder, flake, platelet, wire, nanowire, or vacuum metallized pigment.

In the method, the cathode can be porous. The cathode can have a porosity of 20% to 55%. The cathode can have a porosity of 20% to 35%. In one version of the method, the cathode is free of binder other than the metallic material. In one version of the method, the cathode is free of conductive carbon. In one version of the method, the cathode has a peak flexural strength of greater than 50 MPa as measured by a three-point bend test according to test standard ASTM D7264. The cathode can have a peak flexural strength of greater than 100 MPa as measured by a three-point bend test according to test standard ASTM D7264. The cathode can have a peak flexural strength of greater than 150 MPa as measured by a three-point bend test according to test standard ASTM D7264.

In one version of the method, step (b) further comprises forming the slurry to include a binder, and step (d) further comprises burning out the binder at a temperature in a range of 300° C. to 500° C. Step (d) may further comprise sintering the layer at a temperature in a range of 20° C. to 450° C. under pressure range of 1 MPa to 400 MPa. The method may further comprise infiltrating the electrode with a liquid lithium ion conducting electrolyte, a lithium ion conducting polymer, or a lithium ion conducting ionic liquid. The method may further comprise bonding a solid electrolyte to the electrode at a temperature in a range of 20° C. to 450° C. under pressure range of 1 MPa to 400 MPa. In one version of the method, step (c) comprises casting the slurry on the surface to form the layer; or spraying the slurry on the surface to form the layer. The method may further comprise (e) drying the electrode, (f) calendaring the electrode, and (g) integrating the electrode into lithium ion or solid-state battery. In one version of the method, the slurry does not include a binder. In one version of the method, the slurry does not include conductive carbon. In one version of the method, the surface is a surface of a current collector.

In another aspect, the present disclosure provides a porous electrode for an electrochemical device. The electrode may comprise a lithium host material and a metallic material, wherein the metallic material comprises an elementally pure metal or an alloy thereof. The electrode may be free of binder other than the metallic material.

In another aspect, the present disclosure provides a conductive additive for a porous electrode of an electrochemical device. The conductive additive comprises a conductive metallic material.

In another aspect, the present disclosure provides an electrochemical device comprising a cathode including a liquid, polymer or gel electrolyte material incorporated therein. The liquid, polymer or gel electrolyte is contained within pores of the cathode. The described cathode may be free of binder other than the metallic material. The described cathode may be free of conductive carbon.

In another aspect, the present disclosure provides an electrochemical device comprising an anode including a solid electrolyte material incorporated therein.

In another aspect, the present disclosure provides an electrochemical device comprising a current collector comprising a conductive substrate material.

Further, the present disclosure provides a method of binding a lithium host material with a metallic material, wherein the metallic material comprises an elementally pure metal or an alloy thereof. The metallic material can be in a form selected from powder, flake, platelet, wire, nanowire, or vacuum metallized pigment.

In one aspect, the present disclosure provides a method for forming an electrode for an electrochemical device from a slurry. The method includes steps of: (a) depositing a metallic material on a powdered lithium host material; (b) forming a slurry comprising the metallic material coated lithium host material; (c) casting the slurry on a surface to form a layer; and (d) sintering the layer to form the electrode.

In another aspect, the present disclosure provides a method for forming an electrode for an electrochemical device from a slurry. The method includes steps of: (a) depositing a metallic material on a powdered lithium host material; (b) forming a slurry comprising the metallic material coated lithium host material; (c) spraying the slurry on a surface to form a layer; and (d) sintering the layer to form the electrode.

In another aspect, the present disclosure provides a method for forming an electrode for an electrochemical device from a slurry. The method includes steps of: (a) depositing a metallic material on a powdered lithium host material; (b) forming a slurry comprising the metallic material coated lithium host material; (c) placing the slurry on a surface to form a layer; (e) drying the electrode; (f) calendaring the electrode, and (g) integrating the electrode into lithium ion or solid-state battery.

In another aspect, the present disclosure provides a method for forming an electrode for an electrochemical device from a slurry. The method includes steps of: (a) depositing a metallic material on a powdered lithium host material; (b) forming a slurry comprising the metallic material coated lithium host material and a conductive additive; (c) placing the slurry on a surface to form a layer; (e) drying the electrode; (f) calendaring the electrode, and (g) integrating the electrode into lithium ion or solid-state battery.

These and other features, aspects, and advantages of the present invention will become better understood upon consideration of the following detailed description, drawings and appended claims.

### BRIEF DESCRIPTION OF THE DRAWINGS

FIG. 1 is a schematic of a lithium ion battery.

FIG. 2 is a schematic of a lithium metal battery.

FIG. 3 is a detailed view of the lithium metal battery of FIG. 2 taken along line 3-3 of FIG. 2.

FIG. 4 is a detailed view similar to FIG. 3 of a prior art lithium ion battery.

FIG. 5 is a graph of voltage vs. capacity for a 5 volume % aluminum in LiCoO₂ (LCO) composite cathode for 0.1 C cycling.

FIG. 6A is a micrograph of a razor scratch test of a conventional lithium ion cathode electrode consisting of PVDF, carbon black and active material.

FIG. 6B is a micrograph of a razor scratch test of an aluminum/LCO cermet electrode according to one embodiment of the invention.

FIG. 7 shows a three-point bend test of a LiCoO₂/aluminum cermet cathode electrode according to one embodiment of the invention on an aluminum current collector.

Like reference numerals will be used to refer to like parts from Figure to Figure in the following description of the drawings.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. Skilled artisans will recognize the examples provided herein have many useful alternatives and fall within the scope of embodiments of the invention.

The present invention discloses a mechanically robust cathode that supports a solid state electrolyte in a lithium metal battery. A metallic conductive additive acts as a conductive diluent and adheres particles of active material together. Furthermore, this invention provides methods for fabricating the cathode.

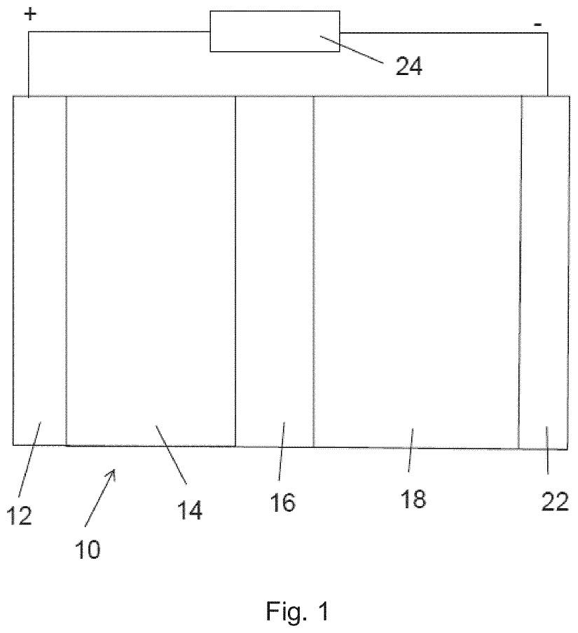

FIG. 1 shows a non-limiting example application of a lithium ion battery 10 according to one embodiment of the present disclosure. The lithium ion battery 10 includes a first current collector 12 (e.g., aluminum) in contact with a cathode 14. A solid state electrolyte 16 is arranged between the cathode 14 and an anode 18, which is in contact with a second current collector 22 (e.g., aluminum). The first and second current collectors 12 and 22 of the lithium ion battery 10 may be in electrical communication with an electrical component 24. The electrical component 24 could place the lithium ion battery 10 in electrical communication with an electrical load that discharges the battery or a charger that charges the battery.

A suitable active material for the cathode 14 of the lithium ion battery 10 is a lithium host material capable of storing and subsequently releasing lithium ions. An example cathode active material is a lithium metal oxide wherein the metal is one or more aluminum, cobalt, iron, manganese, nickel and vanadium. Non-limiting example lithium metal oxides are LiCoO₂ (LCO), LiFeO₂, LiMnO₂ (LMO), LiMn₂O₄, LiNiO₂ (LNO), LiNiₐCo_{b}O₂, LiMnₐCo_{b}O₂, LiMnₐNi_{b}O₂, LiMnₐNi_{b}O₄, LiNi_{1/3}Mn_{1/3}CO_{1/3}O₂, LiFePO₄, LiCoPO₄, Li(CoₓFe_{y}Ni_{z})PO₄, LiCoO₂, Li(NiₓMn_{y}Co_{z})O₂, Li(NiₓCo_{y}Al_{z})O₂, LiNiO₂, Li(NiₓMn_{y})O₄, or LiMn₂O₄, wherein x+y+z =1. Another example of cathode active materials is a lithium-containing phosphate having a general formula LiMPO₄ wherein M is one or more of cobalt, iron, manganese, and nickel, such as lithium iron phosphate (LFP) and lithium iron fluorophosphates. The cathode lithium host material can be a mixture of any number of these cathode active materials.

In some aspects, the cathode 14 may include a conductive additive. Many different conductive additives, e.g., Co, Mn, Ni, Cr, Al, or Li, may be substituted or additionally added into the structure to influence electronic conductivity, ordering of the layer, stability on delithiation and cycling performance of the cathode materials. Other suitable conductive additives include graphite, carbon black, acetylene black, Ketjen black, channel black, furnace black, lamp black, thermal black, conductive fibers, metallic powders, conductive whiskers, conductive metal oxides, and mixtures thereof.

A suitable active material for the anode 18 of the lithium ion battery 10 is a lithium host material capable of incorporating and subsequently releasing the lithium ion such as graphite, a lithium metal oxide (e.g., lithium titanium oxide), hard carbon, a tin/cobalt alloy, or silicon/carbon. The anode active material can be a mixture of any number of these anode active materials. In some embodiments, the anode 18 may also include one or more conductive additives similar to those listed above for the cathode 14.

A suitable solid state electrolyte 16 of the lithium ion battery 10 includes an electrolyte material having the formula LiᵤReᵥM_{w}AₓO_{y}, wherein
Re can be any combination of elements with a nominal valance of +3 including La, Nd, Pr, Pm, Sm, Sc, Eu, Gd, Tb, Dy, Y, Ho, Er, Tm, Yb, and Lu;
M can be any combination of metals with a nominal valance of +3, +4, +5 or +6 including Zr, Ta, Nb, Sb, W, Hf, Sn, Ti, V, Bi, Ge, and Si;
A can be any combination of dopant atoms with nominal valance of +1, +2, +3 or +4 including H, Na, K, Rb, Cs, Ba, Sr, Ca, Mg, Fe, Co, Ni, Cu, Zn, Ga, Al, B, and Mn;
u can vary from 3-7.5;
v can vary from 0-3;
w can vary from 0-2;
x can vary from 0-2; and
y can vary from 11-12.5.
   The electrolyte material may be a lithium lanthanum zirconium oxide. The electrolyte material may have the formula Li_{6.25}La_{2.7}Zr₂Al_{0.25}O₁₂.

Another example solid state electrolyte 16 can include any combination oxide or phosphate materials with a garnet, perovskite, NaSICON, or LiSICON phase. The solid state electrolyte 16 of the lithium ion battery 10 can include any solid-like material capable of storing and transporting ions between the anode 18 and the cathode 14.

The current collector 12 and the current collector 22 can comprise a conductive material. For example, the current collector 12 and the current collector 22 may comprise molybdenum, aluminum, nickel, copper, combinations and alloys thereof or stainless steel.

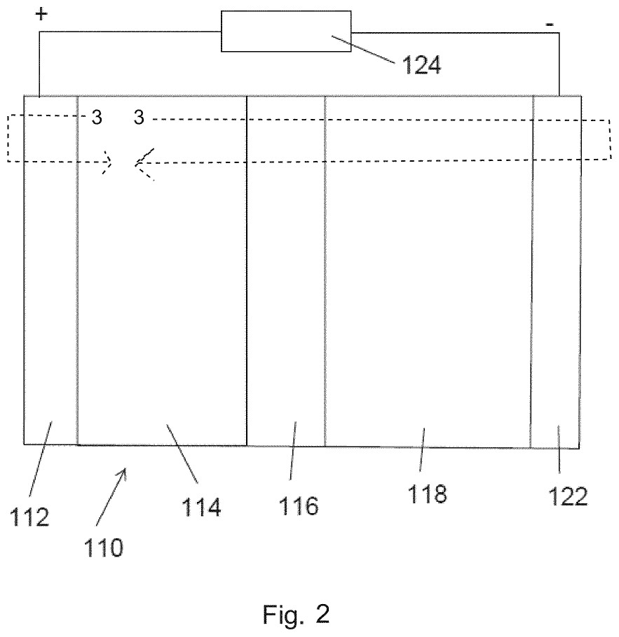

FIG. 2 shows a non-limiting example application of a lithium metal battery 110 according to one embodiment of the present disclosure. The lithium metal battery 110 includes a current collector 112 in contact with a cathode 114. A solid state electrolyte 116 is arranged between the cathode 114 and an anode 118, which is in contact with a current collector 122. The current collectors 112 and 122 of the lithium metal battery 110 may be in electrical communication with an electrical component 124. The electrical component 124 could place the lithium metal battery 110 in electrical communication with an electrical load that discharges the battery or a charger that charges the battery. A suitable active material for the anode 118 of the lithium metal battery 110 is lithium metal. A suitable solid state electrolyte material for the solid state electrolyte 116 of the lithium metal battery 110 is one or more of the solid state electrolyte materials listed above for battery 10.

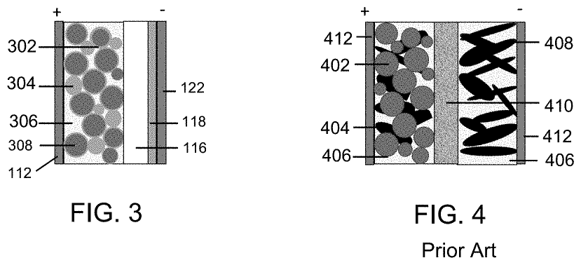

FIG. 3 shows an enlarged, schematic illustration of an internal volume of the lithium metal battery 110 according to one embodiment of the present disclosure. The internal volume of the porous cathode of the lithium metal battery 110 includes a lithium host material 308 and a liquid, polymer or gel electrolyte 306 dispersed throughout. In some embodiments, the cathode has a porosity of 20% to 55%, or 20% to 35%. In some embodiments, an aluminum coating is configured to coat at least a portion of the lithium host material 308 to form an aluminum coated lithium host material 302. In some embodiments, an aluminum binder 304 is dispersed throughout the liquid, polymer or gel electrolyte 306. A metallic anode 118 (e.g., lithium metal) is arranged between the solid electrolyte 116 and current collectors 112 and 122.

A suitable liquid electrolyte 306 comprises a solvent and a lithium salt. The lithium salt can be selected from the group consisting of LiN(CF₃SO₂)₂ (LiTFSI), lithium bis(fluorosulfonyl)imide (LiFSI), LiCF₃SO₃ (LiTf), lithium bis(oxalato)borate (LiBOB), LiPF₆, Lil, LiBF₄, LiBr, LiCl, LiF, Li₂SO₄, lithium bis(trifluoromethanesulfonyl)azanide (LiTFSA), LiCF₃SO₃, and mixtures thereof. The solvent can be selected from the group consisting of propylene carbonate (PC), dimethyl sulfoxide (DMSO), dimethylformamide (DMF), dimethylacetamide (DMAc), fluorinated ethers, fluorinated linear carboxylates, γ-butyrolactone, fluorinated γ-butyrolactone, tetraethylene glycol dimethyl ether, triethylene glycol dimethyl ether, bis(2-methoxyethyl) ether, ethyl methyl sulfone, allyl methyl sulfone, high oxidative stability solvents, and mixtures thereof. The liquid electrolyte 306 of the lithium metal battery 110 can include any liquid-like material capable of storing and transporting ions between the anode and the cathode.

A suitable gel electrolyte 306 comprises a liquid electrolyte as described above entrapped in a solid gel network. Non-limiting examples of solid gel network are poly(vinylidene fluoride-co-hexafluoropropylene) (PVDF-HFP), poly(methyl methacrylate) (PMMA), polyacrylonitrile (PAN), poly-(D)-glucosamine, polyethylene oxide (PEO), polyvinyl chloride (PVC), a polysaccharide, polyethylene glycol dimethacrylate (PEG-DMA), or polyvinylpyrrolidone (PVP). The gel electrolyte 306 of the lithium metal battery 110 can include any gel-like material capable of storing and transporting ions between the anode and the cathode.

A suitable polymer electrolyte 306 comprises a polymer matrix and a lithium salt. Non limiting examples of a polymer matrix are polyethylene oxide (PEO), polypropylene oxide (PPO), poly[bis(methoxy-ethoxy-ethoxy)phosphazene] (MEEP), polysiloxane (PSi), and mixtures thereof. Non limiting examples of lithium salts are LiClO₄, LiBF₄, LiPF₆, LiAsF₆, LiCF₃SO₃, LiN(CF₃SO₂)₂, and mixtures thereof. The polymer electrolyte 306 of the lithium metal battery 110 can include any liquid-like material capable of storing and transporting ions between the anode and the cathode.

FIG. 4 shows an enlarged, schematic illustration of an internal volume of a conventional lithium-ion battery. The internal volume of the cathode of the lithium-ion battery includes a lithium host material 402, a conductive carbon and binder 404 and a liquid electrolyte 406 dispersed throughout. A separator 410 is arranged between the cathode and the anode of the conventional lithium-ion battery. The internal volume of the liquid electrolyte 406 includes at least one graphite anode 408. The conventional lithium-ion battery further comprises a current collector 412.

In one non-limiting example embodiment of an electrode of the invention, there is provided a positive electrode of a lithium battery in which active lithium host material is bound together with a metal particle or coating serving as a binder and electronic conductor. The active material can be selected from the group consisting of LiFePO₄, LiCoPO₄, Li(CoₓFe_{y}Ni_{z})PO₄, LiCoO₂, Li(NiₓMn_{y}Co_{z})O₂, Li(NiₓCo_{y}Al_{z})O₂, LiNiO₂, Li(NiₓMn_{y})O₄, and LiMn₂O₄, where x+y+z=1. The metal particle or coating can be elementally pure aluminum or alloys thereof. The aluminum or aluminum alloy can be in the form of powder, flake, platelet, wire, nanowire, or vacuum metallized pigment. The aluminum or aluminum alloy can be either mechanically transferred to the cathode through a milling process or mixed with active material, binder, and solvent in shear mixing device.

In one non-limiting example embodiment of a method of the invention, the active material and aluminum are mixed with solvent and binder to form a slurry and cast on aluminum foil or other current collector by doctor blade, slot die, or similar coating technology to form an porous metal-ceramic composite electrode. The electrode is burned out between 300° C.-500° C. in air or oxygen to remove binder. The electrode is then densified under 1-400 MPa pressure at 20° C.-450° C. The porous metal-ceramic composite electrode is then infiltrated with a liquid lithium ion conducting electrolyte, a lithium ion conducting polymer, or a lithium ion conducting ionic liquid. A separate heat treatment of the electrode between 20° C.-650° C. may provide particle bonding without decreasing porosity. When no binder is added to the slurry, no burn out step is needed. The porous metal-ceramic composite electrode can be bonded to a solid electrolyte under 1-400 MPa pressure at 20° C.-450° C.

In another non-limiting example embodiment of a method of the invention, the active material and a metallic material (e.g., aluminum) are mixed with solvent and binder to form a slurry and sprayed on aluminum foil or other current collector to form an porous metal-ceramic composite electrode. The electrode is burned out between 300-500° C. in air or oxygen to remove binder. The electrode is then densified under 1-400 MPa pressure at 20° C.-450° C. The porous metal-ceramic composite electrode is then infiltrated with a liquid lithium ion conducting electrolyte, a lithium ion conducting polymer, or a lithium ion conducting ionic liquid. A separate heat treatment of the electrode between 20° C.-650° C. may provide particle bonding without decreasing porosity. When no binder is added to the slurry, no burn out step is needed. The porous metal-ceramic composite electrode can be bonded to a solid electrolyte under 1-400 MPa pressure at 20° C.-450° C.

In yet another non-limiting example embodiment of a method of the invention, the active material and a metallic material (e.g., aluminum) are mixed with a solvent and a binder to form a slurry and cast on aluminum foil or other current collector by doctor blade, slot die, or similar coating technology to form an electrode. The electrode is then dried, calendered, and can be integrated into lithium ion or solid-state battery.

In still another non-limiting example embodiment of a method of the invention, a metallic material (e.g., aluminum) is added to the active material, binder, conductive additive, and solvent slurry of a conventional lithium-ion cast electrode. The metallic material (e.g., aluminum) may completely or partially substitute for the conventional conductive additive. The slurry can be cast on aluminum foil or other metallic current collector by doctor blade, slot die, or similar coating technology to form an electrode. After drying and calendering, the electrode can be used in a lithium-ion battery.

In some embodiments, the metallic material (e.g., aluminum) interparticle connection and thin film format provide a degree of bending without fracturing the composite cathode. The described cathodes may be integrated into conventional lithium-ion roll-to-roll manufacturing. In one embodiment, a metallic material (e.g., aluminum) may partially or completely substitute conductive carbon to serve as a conductive additive to improve high voltage stability to the cathode.

In some embodiments, aluminum is a cathode binder. This embodiment eliminates the use of PVDF or other polymer binder and therefore eliminates the use of hazardous solvents, such as N-Methyl-2-pyrrolidone (NMP).

In some embodiments, the carbon conductive additive can be either partially or completely replaced by a metallic material (e.g., aluminum) in conventional lithium-ion electrodes, which may allow for higher stability with next-generation high voltage cathodes (5.0V).

### Forming an Electrode for an Electrochemical Device

In one embodiment, the present disclosure relates to forming an electrode for use in an electrochemical device, such as a lithium ion battery or a lithium metal battery. In general, the method relates to binding a lithium host material with a metallic material (e.g., aluminum) during fabrication. A suitable lithium host material for the electrode is one or more of the lithium host materials listed above for a lithium battery.

In one embodiment, the method for forming an electrode includes binding a lithium host material and a metallic material with a binder and a solvent to form a slurry. The slurry is then cast on a surface to form a layer, and the layer is sintered to form an electrode.

In another embodiment, the electrode may be produced by forming a slurry comprising a lithium host material, a metallic material, a binder and a solvent. The slurry is then sprayed on a surface to form a layer. The layer is then sintered to form an electrode.

The slurry as described in any of the preceding embodiments may be formed by mixing the lithium host material or coated lithium host material with an aqueous or organic solvent. Suitable solvents may include N-methyl-2-pyrrolidone (NMP) or other suitable alternatives that would be readily understood to those skilled in the art. A binder may also be added to the slurry, such as polyvinylidene fluoride (PVDF) or any suitable alternative that would be readily understood to those skilled in the art.

The slurry as described in any of the proceeding embodiments may comprise 0.1 to 20 volume percent of a metallic material based on a total volume of the metallic material and the lithium host material. The metallic material may comprise elementally pure aluminum or an alloy thereof. The metallic material can be in a form selected from powder, flake, platelet, wire, nanowire, or vacuum metallized pigment. The slurry can be casted or sprayed on a surface to form a layer. The layer is then sintered to form an electrode.

The layer of the electrode as discussed in any of the preceding embodiments may be burned out at a temperature between 300° C. to 500° C. in air or oxygen to remove binder. The electrode is then densified under 1 MPa-400 MPa pressure at 20° C.-450° C. The porous metal-ceramic composite electrode is then infiltrated with a liquid lithium ion conducting electrolyte, a lithium ion conducting polymer, or a lithium ion conducting ionic liquid. A separate heat treatment of the electrode between 20° C.-650° C. may provide particle bonding without decreasing porosity. When no binder is added to the slurry, no burn out step is needed. The porous metal-ceramic composite electrode is then bonded to a solid electrolyte under 1 MPA-400 MPa pressure at 20° C.-450° C. In one embodiment, the electrode is a cathode, has a porosity of 20% to 55%, or 20% to 35%, is free of binder other than the metallic material, and is free of conductive carbon. The electrode may have a peak flexural strength of greater than 50 MPa, or greater than 100 MPa, or greater than 150 MPa as measured by a three-point bend test according to test standard ASTM D7264.

In another non-limiting example embodiment of a method of the invention, the active material and a metallic material (e.g., aluminum) are mixed with a solvent and a binder to form a slurry and cast on aluminum foil or other current collector by doctor blade, slot die, or similar coating technology to form an electrode. The electrode is then dried, calendered, and can be integrated into lithium ion or solid-state battery.

In yet another non-limiting example embodiment of a method of the invention, a metallic material (e.g., aluminum) is added to the active material, binder, conductive additive, and solvent slurry of a conventional lithium-ion cast electrode. The aluminum may completely or partially substitute for the conventional conductive additive. The slurry can be cast on aluminum foil or other current collector by doctor blade, slot die, or similar coating technology to form an electrode. After drying and calendering, the electrode can be used in a lithium-ion battery.

The anode and cathode as discussed in any of the preceding embodiments each may have a thickness that ranges between 1 to 200 microns. In some embodiments, the thickness each of the anode and cathode is less than 175 microns, or less than 150 microns, or less than 125 microns, or less than 100 microns, or less than 75 microns, or less than 50 microns.

The solid state electrolyte as discussed in any of the preceding embodiments may be sintered to have a thickness that ranges between 1 to 100 microns. In some embodiments, the thickness of the solid state electrolyte is less than 90 microns, or less than 80 microns, or less than 70 microns, or less than 60 microns, or less than 50 microns, or less than 30 microns, or less than 20 microns.

### EXAMPLES

The following Examples have been presented in order to further illustrate the invention and are not intended to limit the invention in any way.

### Example 1

A composite was formed by applying 5 volume % aluminum to commercial LiCoO₂ (LCO) active material by gentle planetary ball milling. This composite was mixed with poly(methyl methacrylate/n-butyl methacrylate), dibutyl phthalate, and dimethylformamide and cast onto an aluminum current collector by doctor blade. The binder was burned out at 450° C., and samples were densified at 100-200° C. under 200 MPa uniaxial pressure to produce a load-bearing metal-ceramic cathode film.

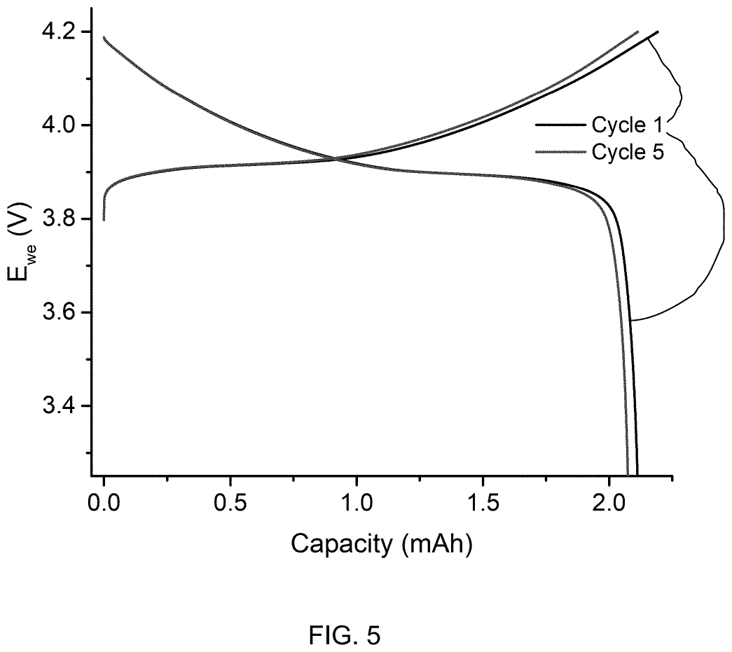

The cathode film retains 20-55% porosity. Liquid electrolyte, such as those used in a state of the art lithium-ion battery, can be infiltrated into the porosity to provide a continuous ionic pathway to the cathode particles. The aluminum particles provide both mechanical strength and electronic conduction. FIG. 5 shows a charge discharge curve for a 5 volume % aluminum/LCO composite infiltrated with liquid electrolyte at 0.1 C. Up to 97% of cathode rated capacity was achieved on first cycle discharge at 0.1 C.

### Example 2

LCO has intrinsic semiconducting and metallic conducting properties, depending on the degree of litihiation. Example 1 was repeated with 5 volume % aluminum in Li(Ni_{0.33}Mn_{0.33}Co_{0.33})O₂, an lithium host material with low electronic conductivity. Capacities of 94% of theoretical were reached at 0.1 C. This example demonstrates that sufficient electronic conductivity is provided by the aluminum flake in a low conductive material. This example also demonstrates that aluminum flakes can be added to state of the art cathode materials and provide sufficient conductivity.

### Example 3

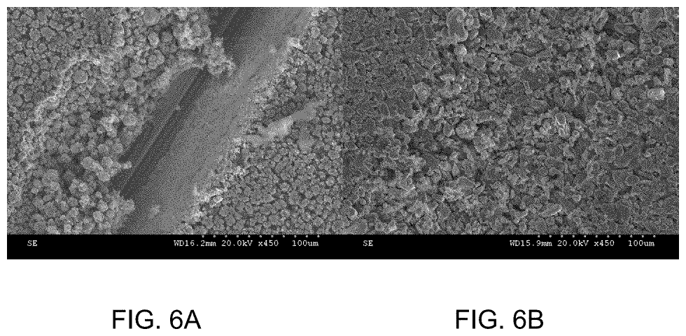

The cathode films they can then be used to support thin solid-electrolyte separator films to form hybrid solid-liquid electrolyte full cells with lithium metal anode due to the mechanical strength. FIG. 6A shows a micrograph of a razor scratch test of a conventional lithium ion cathode electrode consisting of PVDF, carbon black and active material. FIG. 6B shows a micrograph of a razor scratch test of a porous cermet cathode with 5 volume % aluminum in LCO. As shown in FIG. 6A, the scratch penetrates deeply into the conventional lithium ion cathode electrode. FIG. 6B shows a razor scratch test of the aluminum/LCO cermet electrode of Example 1 with less damage to the electrode structure.

### Example 4

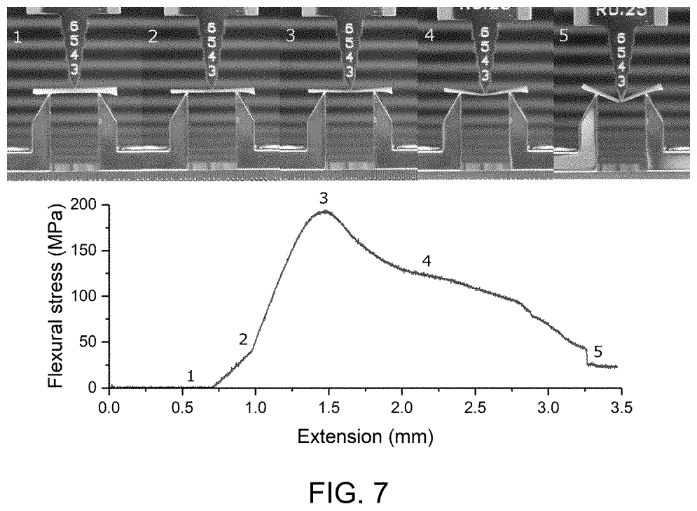

A three-point bend test according to test standard ASTM D7264/D7264M-15, Standard Test Method for Flexural Properties of Polymer Matrix Composite Materials, ASTM International, West Conshohocken, Pa., 2015 was performed on the aluminum/LCO cermet electrode of Example 1. FIG. 7 shows a three-point bend test of the aluminum/LCO cermet cathode electrode on an aluminum current collector. The sample shows a peak flexural strength of 187 MPa, more than ten times that of the un-densified composite and four times that of a commercial Li-ion positive electrode. The high flexural strength is a consequence of the well dispersed aluminum particles holding together LCO active material particles.

Thus, the invention provides electrochemical devices, such as lithium battery electrodes, and solid-state lithium ion and lithium metal batteries including these electrodes. This invention also provides to methods for making such electrochemical devices.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. A cathode comprising:
a lithium host material; and
a metallic material,
wherein the lithium host material is bound together with the metallic material serving as a binder and an electronic conductor.

2. The cathode of claim 1 wherein:
the cathode is a cermet cathode.

3. The cathode of claim 1 wherein:
the lithium host material is selected from the group consisting of lithium metal oxides wherein the metal is one or more aluminum, cobalt, iron, manganese, nickel and vanadium, and lithium-containing phosphates having a general formula LiMPO₄ wherein M is one or more of cobalt, iron, manganese, and nickel.

4. The cathode of claim 3 wherein:
the lithium host material is selected from the group consisting of LiFePO₄, LiCoPO₄, Li(CoₓFe_{y}Ni_{z})PO₄, LiCoO₂, Li(NiₓMn_{y}Co_{z})O₂, Li(NiₓCo_{y}Al_{z})O₂, LiNiO₂, Li(NiₓMn_{y})O₄, or LiMn₂O₄, wherein x+y+z=1.

5. The cathode of claim 1 further comprising:
a liquid electrolyte contained within pores of the cathode.

6. The cathode of claim 5 wherein:
the liquid electrolyte comprises a solvent and a lithium salt.

7. The cathode of claim 6 wherein:
the lithium salt is selected from the group consisting of LiN(CF₃SO₂)₂ (LiTFSI), lithium bis(fluorosulfonyl)imide (LiFSI), LiCF₃SO₃ (LiTf), lithium bis(oxalato)borate (LiBOB), LiPF₆, Lil, LiBF₄, LiBr, LiCl, LiF, Li₂SO₄,
lithium bis(trifluoromethanesulfonyl)azanide (LiTFSA), LiCF₃SO₃, and mixtures thereof.

8. The cathode of claim 6 wherein:
the solvent is selected from the group consisting of propylene carbonate (PC), dimethyl sulfoxide (DMSO), dimethylformamide (DMF), dimethylacetamide (DMAc), fluorinated ethers, fluorinated linear carboxylates, γ-butyrolactone, fluorinated γ-butyrolactone, tetraethylene glycol dimethyl ether, triethylene glycol dimethyl ether, bis(2-methoxyethyl) ether, ethyl methyl sulfone, allyl methyl sulfone, high oxidative stability solvents, and mixtures thereof.

9. The cathode of claim 5 wherein:
the liquid electrolyte is entrapped in a solid gel network comprising poly(vinylidene fluoride-co-hexafluoropropylene) (PVDF-HFP), poly(methyl methacrylate) (PMMA), polyacrylonitrile (PAN), poly-(D)-glucosamine, polyethylene oxide (PEO), polyvinyl chloride (PVC), a polysaccharide, polyethylene glycol dimethacrylate (PEG-DMA), or polyvinylpyrrolidone (PVP).

10. The cathode of claim 1 further comprising:
a polymer electrolyte contained within pores of the cathode.

11. The cathode of claim 10 wherein:
the polymer electrolyte comprises a polymer matrix and a lithium salt.

12. The cathode of claim 11 wherein:
the polymer matrix comprises polymer selected from the group consisting of polyethylene oxide (PEO), polypropylene oxide (PPO), poly[bis(methoxy-ethoxy-ethoxy)phosphazene] (MEEP), polysiloxane (PSi), and mixtures thereof, and
the lithium salt is selected from the group consisting of LiClO₄, LiBF₄, LiPF₆, LiAsF₆, LiCF₃SO₃, LiN(CF₃SO₂)₂, and mixtures thereof.

13. The cathode of claim 1 wherein:
the metallic material comprises an elementally pure metal or an alloy thereof.

14. The cathode of claim 1 wherein:
the metallic material comprises 0.1 to 20 volume percent based on a total volume of the metallic material and the lithium host material.

15. The cathode of claim 1 wherein:
the metallic material comprises 1 to 10 volume percent based on a total volume of the metallic material and the lithium host material.

16. The cathode of claim 1 wherein:
the metallic material comprises elementally pure aluminum or an alloy thereof.

17. The cathode of claim 1 wherein:
the metallic material is in a form selected from powder, flake, platelet, wire, nanowire, or vacuum metallized pigment.

18. The cathode of claim 1 wherein:
the cathode is porous.

19. The cathode of claim 18 wherein:
the cathode has a porosity of 20% to 55%.

20. The cathode of claim 18 wherein:
the cathode has a porosity of 20% to 35%.

21. The cathode of claim 1 wherein:
the cathode has a peak flexural strength of greater than 50 MPa as measured by a three-point bend test according to test standard ASTM D7264.

22. The cathode of claim 1 wherein:
the cathode has a peak flexural strength of greater than 100 MPa as measured by a three-point bend test according to test standard ASTM D7264.

23. The method of claim 1 wherein:
the cathode has a peak flexural strength of greater than 150 MPa as measured by a three-point bend test according to test standard ASTM D7264.

24. The cathode of claim 1 wherein:
the cathode is free of binder other than the metallic material.

25. The cathode of claim 1 wherein:
the cathode is free of conductive carbon.

26. An electrochemical device comprising:
the cathode of claim 1;
an anode; and
a solid state electrolyte between the anode and the cathode.

27. The electrochemical device of claim 26 wherein:
the solid state electrolyte comprises an electrolyte material having the formula LiᵤReᵥM_{w}AₓO_{y}, wherein
Re can be any combination of elements with a nominal valance of +3 including La, Nd, Pr, Pm, Sm, Sc, Eu, Gd, Tb, Dy, Y, Ho, Er, Tm, Yb, and Lu;
M can be any combination of metals with a nominal valance of +3, +4, +5 or+6 including Zr, Ta, Nb, Sb, W, Hf, Sn, Ti, V, Bi, Ge, and Si;
A can be any combination of dopant atoms with nominal valance of +1, +2, +3 or+4 including H, Na, K, Rb, Cs, Ba, Sr, Ca, Mg, Fe, Co, Ni, Cu, Zn, Ga, Al, B, and Mn;
u can vary from 3-7.5;
v can vary from 0-3;
w can vary from 0-2;
x can vary from 0-2; and
y can vary from 11-12.5.

28. The electrochemical device of claim 26 wherein:
the anode comprises an anode material selected from the group consisting of graphite, lithium metal, lithium titanium oxides, hard carbon, tin/cobalt alloy, or silicon/carbon.

29. The electrochemical device of claim 26 wherein:
the anode comprises lithium metal.

30. A method for forming an electrode for an electrochemical device, the method comprising:
(a) depositing a metallic material on a powdered lithium host material;
(b) forming a slurry comprising the metallic material coated lithium host material;
(c) placing the slurry on a surface to form a layer; and
(d) sintering the layer to form the electrode.

31. The method of claim 30 wherein:
the electrode is a cathode.

32. The method of claim 31 wherein:
the lithium host material is selected from the group consisting of lithium metal oxides wherein the metal is one or more aluminum, cobalt, iron, manganese, nickel and vanadium, and lithium-containing phosphates having a general formula LiMPO₄ wherein M is one or more of cobalt, iron, manganese, and nickel.

33. The method of claim 31 wherein:
the lithium host material is selected from the group consisting of LiFePO₄, LiCoPO₄, Li(CoₓFe_{y}Ni_{z})PO₄, LiCoO₂, Li(NiₓMn_{y}Co_{z})O₂, Li(NiₓCo_{y}Al_{z})O₂, LiNiO₂, Li(NiₓMn_{y})O₄, or LiMn₂O₄, wherein x+y+z=1.

34. The method of claim 31 wherein:
the metallic material comprises an elementally pure metal or an alloy thereof.

35. The method of claim 31 wherein:
the metallic material comprises 0.1 to 20 volume percent based on a total volume of the metallic material and the lithium host material.

36. The method of claim 31 wherein:
the metallic material comprises 1 to 10 volume percent based on a total volume of the metallic material and the lithium host material.

37. The method of claim 31 wherein:
the metallic material comprises elementally pure aluminum or an alloy thereof.

38. The method of claim 31 wherein:
the metallic material is in a form selected from powder, flake, platelet, wire, nanowire, or vacuum metallized pigment.

39. The method of claim 31 wherein:
the cathode is porous.

40. The method of claim 39 wherein:
the cathode has a porosity of 20% to 55%.

41. The method of claim 39 wherein:
the cathode has a porosity of 20% to 35%.

42. The method of claim 31 wherein:
the cathode is free of binder other than the metallic material.

43. The method of claim 31 wherein:
the cathode is free of conductive carbon.

44. The method of claim 31 wherein:
the cathode has a peak flexural strength of greater than 50 MPa as measured by a three-point bend test according to test standard ASTM D7264.

45. The method of claim 31 wherein:
the cathode has a peak flexural strength of greater than 100 MPa as measured by a three-point bend test according to test standard ASTM D7264.

46. The method of claim 31 wherein:
the cathode has a peak flexural strength of greater than 150 MPa as measured by a three-point bend test according to test standard ASTM D7264.

47. The method of claim 30 wherein:
step (b) further comprises forming the slurry to include a binder, and
step (d) further comprises burning out the binder at a temperature in a range of 300° C. to 500° C.

48. The method of claim 30 wherein:
step (d) further comprises sintering the layer at a temperature in a range of 20° C. to 450° C. under pressure range of 1 MPa to 400 MPa.

49. The method of claim 31 further comprising:
(e) infiltrating the electrode with a liquid lithium ion conducting electrolyte, a lithium ion conducting polymer, or a lithium ion conducting ionic liquid.

50. The method of claim 49 further comprising:
(f) bonding a solid electrolyte to the electrode.

51. The method of claim 50 further comprising:
step (f) further comprises bonding at a temperature in a range of 20° C. to 450° C. under pressure range of 1 MPa to 400 MPa.

52. The method of claim 30 wherein:
step (c) comprises casting the slurry on the surface to form the layer; or spraying the slurry on the surface to form the layer.

53. The method of claim 30 further comprising:
(e) drying the electrode,
(f) calendaring the electrode, and
(g) integrating the electrode into lithium ion or solid-state battery.

54. The method of claim 30 wherein:
the slurry does not include a binder.

55. The method of claim 30 wherein:
the slurry does not include conductive carbon.

56. The method of claim 30 wherein:
the surface is a surface of a current collector.
